(19) United States
(12) Patent Application Publication
(10) Pub. No.: US 2018/0108001 A1
(43) Pub. Date: Apr. 19, 2018

(54) VOICE TRIGGERED TRANSACTIONS

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 15/841,178

(22) Filed: Dec. 13, 2017

Related U.S. Application Data
(63) Continuation-in-part of application No. 14/223,678, filed on Mar. 24, 2014.

(51) Int. Cl. G06Q 20/20; G06Q 30/06; G06Q 20/12

(52) U.S. Cl. CPC G06Q 20/206; G06Q 20/12; G06Q 30/0633

(57) ABSTRACT

A voice checkout system and method for electronic commerce uses a voice command to not only initiate/trigger a transaction but also to carry it out with stored information, notifying the POS station/online shopping cart that the transaction has been completed. A customer's microphone provides a recording of a verbal purchase command candidate which is submitted by a portal to a third party processor to verify that the customer is registered and the payment is processed (by the third party processor). An optional biometric voiceprint engine identifies the correct words and vocal patterns of the customer and returns to the seller the information that the transaction is verified.

### RELATED APPLICATION(S)

This application claims the benefit and priority of U.S. patent application Ser. No. 12/223,678 filed on Mar. 24, 2014; in the name of the same inventors, Thomas Jason Taylor and Reyhan Pasinli, the substance of which is incorporated herein in its entirety.

### FIELD OF THE INVENTION

This invention relates generally to point of sale devices such as cash registers, in particular applications to third party assisted voice input/output devices such as may be found in class 705, subclass 24 or 26.44.

### STATEMENT REGARDING FEDERALLY FUNDED RESEARCH

This invention was not made under contract with an agency of the US Government, nor by any agency of the US Government.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever, 37 CFR 1.71(d).

### BACKGROUND

Modern ecommerce requires newer and better methods of facilitating purchases and transactions for goods. In particular, in conventional systems a user would put an item into a shopping cart (real or electronic) and proceed to a point of sale station. At the POS terminal or process, the user would then initiate the process, including indicating that the items in the cart will indeed be purchased. Then the buyer begins a security process, for example, by means of credit card swipe or numeric entry.

In most instances, a customer accesses a network such as the Internet by means of an electronic browsing device such as a computer or telephone. The customer's first transaction requires that they deposit with the retailer their personal financial information such as credit card number, address for physical shipment of the products or performance of the service, and so on.

More recently, neutral third-party/intermediary services have sprung up which hold the customer's financial information. When a purchase is made, the retailer's webpage offers to the customer the option of using the intermediary service PAYPAL® being the most noticeable example) to complete the transaction, that is, to make the payment. This serves several purposes. It allows the customer to input their information into only a single electronic web service, thus reducing the number of times that information is transmitted and the chances of the information being compromised. It allows the retailer to avoid having to gather and safeguard that information.

Significantly, it also renders online commercial activity much faster and more convenient to carry out. This ease of use is very important in online sales, which tend to be made on a more impulse oriented basis than most brick-and-mortar sales.

Usually such services are accessed also through the medium of a webpage, that is, the option to use the intermediary payment service is offered by means of a virtual button or the like. Such buttons are in fact merely part of the HTML/XML/XHTML/JAVA coding of most webpages, with plug-ins or modules which are also supported by standards on both the client side and the server side, such as PHP, ASP.net, HTML5, FLASH, Silverlight, and of course other parts of such a system including operating systems, iOS, Android and the like. The intermediary makes the code for the button module available to the retailer, who incorporates it into their webpage. The webpage itself is normally merely an elaborate coding in HTML/XML/XHTML/JAVA, so this is an extremely easy task to carry out on the part of the retailer's technical staff.

However, whether checkout is by intermediary or directly, it will nonetheless require the user to log in at least once to whichever entity is going to receive and hold the customer's financial data. Thus a customer pushing a ‘PAY USING PAYPAL®’ button will then normally be required to type into their computer their password for that service. While such passwords, especially if the password chosen is simple, may be easier to remember than a credit card number, it is nonetheless more mental clutter for internet shoppers and thus it presents another time barrier to retailers making purchases. In addition, increasingly customers will be accessing websites by means of extremely small and portable devices which may feature tiny keyboards, tiny on-screen keyboards for touch screens, or even no keyboard at all. This slows down the customer even further at a moment when the retailer wants everything to be extremely convenient and quick.

It would be preferable to provide a method and device which allows customers to initiate a check out process via voice recognition technology.

It would be preferable to provide a voice checkout capability which does not require the customer to use a special POS terminal, nor a set-top box, a specially downloaded piece of software, or any other specialized voice payment module.

It would further be preferable to not merely test the candidate voice identification on a pass-fall basis but to gather information which might be useful to detect fraud and provide information as to the probable nature of the fraud: use of tape recordings, interception of pass phrase words by individuals other than the customer, or simply forgetfulness of the customer as to what their pass phrase words actually are. That is, it would be preferable to not only initiate the transaction with a voice command at the POS process, but also to use security features after initiating, such as voice recognition or the like.

However, the present invention does not teach a voice print recognition engine. The present invention is similar to a “checkout” or “add this to cart” command, not a credit card security code replacement.

Various unrelated items of interest include U.S. Pat. No. 8,195,576 to Grigg on Jun. 5, 2012 which teaches that some form of token may be stored on a mobile device, so that a user's mobile device becomes a kind of electronic pass card, key, or credit card. The present invention on the other hand teaches a device-free cloud based third party service which allows any POS system having a microphone to be initiated (not security checked) by means of a voice command to make a purchase. In addition, the Grigg reference teaches that if the token is used, financial information is transferred directly to the POS device, whereas in the present invention only the result of the purchase transaction is sent (a pass/fail indication that a card or account was charged successfully) after the device of the present invention does the financial transaction (the purchase) itself via its own backing network.

U.S. Pat. No. 9,058,607 issued Jun. 16, 2015 to Ganti et al is another unrelated item from the field of fraud detection. Like Kount or Threatmetics (fraud detection systems already on the market), Ganti cannot trigger a transaction, that is, Gamto is not a shopping checkout system, it is NOT relevant to an electronic POS. Ganti provides a score to aid fraud detection, a fraud management system, a fraud operations unit and so on.

US Patent Application Pub. No. 2013/0132091 to Skerpac on May 23, 2013, also does not mention transactions or purchases. This is a biometric security system which identifies the words spoken, but possibly not identity anyway.

It is worth mentioning that while voice recognition may be a part of the present invention, voice recognition is not the point of invention: the present invention relates to purchases

### SUMMARY OF THE INVENTION

The present invention teaches a system and method in which an electronic voice triggered purchase portal offers retailers the ability to embed within normal webpage protocols an option for a consumer to provide a voice pass phrase to make a purchase. The voice pass phrase is then sent as a candidate for voice identification to the voice triggered purchase portal. The portal then provides the verbal identity code candidate to a biometric voiceprint engine (which may or may not be a part of the present invention) to compare the proffered verbal identity code candidate with the saved voice pass phrase.

The portal of the voice purchase system may also maintain customer financial data, in particular credit card number, credit card security codes and credit card billing address and credit card holder name, or in the alternative bank account number and routing number. However, in addition to these other financial data may be maintained, including but not limited to, shipping address for the aforementioned physical step of shipping the product, performance address for the aforementioned physical step of performing a service, and even other data which is financially valuable to retailers such as demographic data, electronic commerce history and so on.

Thus the user's voice command to pay the purchase price (or to add to a shopping cart) is sufficient to trigger the transaction, and the seller's POS need not undertake any financial transaction itself: it merely learns if the transaction has been authorized and occurred. The system is thus a cloud based turn-key POS system offered by the third party to the retailer and consumer.

Another unique aspect of the invention is the elimination of the need for a special purpose “set top box” or application. While the device of the invention may be used in the form of a JAVA® applet, or a cell phone app, a computer application and so on, it is not so limited. In particular, the invention offers the ability to add to a retailer's website a standardized XML/HTML ‘button’ akin to known types of intermediary payment buttons, but which button allows the customer to use the system without any extra effort of downloading an applet or the like. This can include built in browser features or protocols such as FLASH, Silverlight, and so on, or aspects of the operating system itself, such as iOS, Android and so on. The user may simply activate the ‘button’ and then the webpage activates the user's electronic browsing device microphone (the microphone on a computer, a tablet, a telephone, etc) to pick up the user's voice as they recite their purchase instruction, which is not a token stored in the mobile device but rather is a cloud based transaction processor, which may even include a “banking back end” such as MOJOPAY, or PAYPAL or the like.

These and many other aspects, objectives, embodiments and advantages of the present invention will be discussed further below. The above-discussed disadvantages of the reference art are overcome by the system and method of the present invention that provides a simple, yet elegant solution to quickly purchasing a specific product/service without leaving the social network environment if online or having to enter payment information more than once during initial sign-up, or for physical transactions allowing users to virtually skip the POS station process as normally conducted.

It is therefore one embodiment of the present invention to provide a device for checking out, for use by a single customer, the device comprising: a database having a plurality of records, each record associated with such single customer, each record having commercial information associated with such customer; each record having a purchase command associated with such customer; a microphone operative to accept the purchase command and transmit it to the database; a financial transaction system operative to use the commercial information to conduct a complete purchase without further input from such customer, including the steps of: verifying the purchase command; transferring a financial instrument from such customer using the commercial Information associated with such customer; transferring the financial instrument to a first retailer; informing a POS terminal/shopping cart belonging to the first retailer of the successful purchase; and ordering shipment of a product to such customer.

It is therefore another embodiment and objective of the present invention to provide a device for checking out wherein the device for checking out further comprises one member selected from the group consisting of: a POS terminal, a mobile device owned by a brick and mortar retailer, a cloud based third party service, and combinations thereof.

It is therefore another embodiment, advantage and objective of the present invention to provide a device wherein the database is written upon a non-volatile memory medium within at least one computer system.

It is therefore another embodiment, aspect, advantage and objective of the present invention to provide a device wherein the commercial information further comprises: one member selected from the group consisting of: credit card number, credit card security codes, credit card billing address, credit card name, bank account number and routing number, other financial data, shipping address, demographic data, electronic commerce history and combinations thereof.

It is therefore another embodiment and objective of the present invention to provide a device further comprising: a biometric voiceprint engine; the biometric voiceprint engine operative to receive the purchase command and test it against a biometric voiceprint identity information previously registered by such customer and a word choice identity information previously registered by such; a status determination from such biometric voiceprint engine indicating the outcome of the test and assign a test outcome status to the purchase command; the biometric voiceprint engine operative to return the status determination to the financial transaction system.

It is therefore yet another aspect, advantage, objective and embodiment of the invention to provide a method of voice purchase offered by an electronic retailer, for use by a customer having an electronic browsing device, the method comprising the steps of:

providing a database having a plurality of records, each record associated with a single customer,

each record having commercial information associated with such customer,

each record having biometric voiceprint identity information associated with such customer;

each record having word choice identity information associated with such customer;

providing a product/service for purchase by such customer;

transmitting to such customer a purchase page;

offering such customer the option of voice checkout and proceeding with the following steps if the customer elects voice checkout

activating a microphone on such customer's electronic browsing device;

recording the customer's verbal identity code candidate;

transmitting the verbal identity code candidate to a voice checkout portal;

submitting the verbal identity code candidate to a biometric voiceprint engine for testing;

comparing words in the verbal identity code candidate to word choice identity information associated with such customer;

comparing biometric voiceprint information in the verbal identity code candidate to the biometric voiceprint identity information associated with such customer;

based upon the results of the comparisons of the verbal identity code candidate to the information associated with such customer, assigning a test outcome status to the verbal identity code candidate;

returning the test outcome status to such electronic retailer;

determining if the test outcome status is acceptable to such electronic retailer;

if the test outcome status is acceptable to such electronic retailer, completing a purchase, including providing the service/shipping the product;

if the test outcome status is not acceptable to such electronic retailer, determining if the test outcome status merits raising a fraud detection flag;

if the test outcome status does not merit raising a fraud detection flag, determining if such electronic retailer wishes to offer such customer a chance to retry the voice checkout and if so, returning to the step of offering such customer the option of voice checkout.

It is therefore yet another aspect, advantage, objective and embodiment of the invention to provide a method of voice purchase wherein the step of providing a database having a plurality of records, further comprises:

providing an online commerce site:

providing a registration process in turn comprising the steps of:

offering to such customer the opportunity to register for voice checkout;

if such customer accepts the opportunity to register for voice checkout, creating the record associated with such customer;

obtaining from such customer the customer's commercial information and associating that commercial information with such customer in the record;

activating the microphone on such customer's electronic browsing device;

recording a pass phrase including both biometric voiceprint identity information and word choice identity information;

transmitting to the voice checkout portal the pass phrase;

submitting the pass phrase to the biometric voiceprint engine;

associating that information with such customer in the record, including associating the biometric voiceprint identity information and the word choice identity information with the customer.

It is therefore yet another aspect, advantage, objective and embodiment of the invention to provide a method of voice purchase further comprising the step of associating an exact recording information of the pass phrase with such customer in the record, and wherein the step of comparing the biometric voiceprint information further comprises comparing exact audio recording information of the verbal identity code candidate to the exact audio recording information associated with the customer.

It is therefore yet another aspect, advantage, objective and embodiment of the invention to provide a method of voice purchase wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

It is therefore yet another aspect, advantage, objective and embodiment of the invention to provide a method of voice purchase wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

It is therefore yet another aspect, advantage, objective and embodiment of the invention to provide a method of voice purchase wherein the step of comparing biometric voiceprint information further comprises comparing one member selected from the group consisting of: word choice, bandwidth, mean frequency, body cavity resonance, pitch, shape of vowels, distribution of sound energy, pauses, stops, fricatives, plosives and combinations thereof.

It is therefore yet another aspect, advantage, objective and embodiment of the invention to provide a method of voice purchase wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

It is therefore yet another aspect, advantage, objective and embodiment of the invention to provide a method of voice purchase wherein the purchase page is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

It is therefore yet another aspect, advantage, objective and embodiment of the invention to provide a method of voice purchase wherein the transmissions of the method are carried out using one member selected from the group consisting of: the Internet, an intranet, closed garden protocols, voice transmissions and combinations thereof.

It is therefore yet another aspect, advantage, objective and embodiment of the invention to provide an voice purchase portal for use by a customer having an electronic browsing device and an electronic retailer offering an electronic purchase page, the portal comprising:

a database having a plurality of records, each record associated with a single customer,

each record having commercial information associated with such customer;

each record having biometric voiceprint identity information associated with such customer;

each record having word choice identity information associated with such customer;

a purchase page module provided by the voice purchase portal to such electronic retailer for insertion into a purchase page, the purchase page module operative to activate a microphone on such customer's electronic browsing device and record voice information; the purchase page module further operative to transmit such verbal identity code candidate to the voice purchase portal;

the voice purchase portal operative to submit the verbal identity code information to a biometric voiceprint engine;

the biometric voiceprint engine operative to receive a verbal identity code candidate and test it against such biometric voiceprint identity information and such word choice identity information;

a status determination module operative to receive from such biometric voiceprint engine the outcome of such test and assign a test outcome status to the verbal identity code candidate;

the modules of the portal written upon a non-volatile memory medium within at least one computer system.

It is therefore yet another aspect, advantage, objective and embodiment of the invention to provide an voice purchase portal, further comprising:

a registration module operative to offer to such customer the opportunity to register for voice checkout; the registration module further operative to create the record associated with such customer, obtain from such customer the customer's commercial information and associating that commercial information with such customer in the record;

the registration module further operative to activate the microphone on such customer's electronic browsing device and record a pass phrase including both biometric voiceprint identity information and word choice identity information and then submit the pass phrase to the biometric voiceprint engine while associating that information with such customer in the record, including associating the biometric voiceprint identity information and the word choice identity information with the customer.

It is therefore yet another aspect, advantage, objective and embodiment of the invention to provide an voice purchase portal, the registration module further operative to associate an exact recording information of the pass phrase with such customer in the record, the biometric voiceprint engine further operative to compare exact audio recording information of the verbal identity code candidate to the exact audio recording information associated with the customer.

It is therefore yet another aspect, advantage, objective and embodiment of the invention to provide an voice purchase portal, wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

It is therefore yet another aspect, advantage, objective and embodiment of the invention to provide an voice purchase portal, wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

It is therefore yet another aspect, advantage, objective and embodiment of the invention to provide an voice purchase portal, wherein the biometric voiceprint information further comprises one member selected from the group consisting of: word choice, bandwidth, mean frequency, body cavity resonance, pitch, shape of vowels, distribution of sound energy, pauses, stops, fricatives, plosives and combinations thereof.

It is therefore yet another aspect, advantage, objective and embodiment of the invention to provide an voice purchase portal, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

It is therefore yet another aspect, advantage, objective and embodiment of the invention to provide an voice purchase portal, wherein the purchase page module is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

It is therefore yet another aspect, advantage, objective and embodiment of the invention to provide an voice purchase portal, wherein the transmissions of the method are carried out using one member selected from the group consisting of: the Internet, an intranet, closed garden protocols, voice transmissions and combinations thereof.

It is therefore yet another aspect, advantage, objective and embodiment of the invention to provide an voice purchase portal, wherein the biometric voiceprint engine further comprises a neural net having a plurality of nodes, the nodes in turn organized into a plurality of layers including at least a first layer identifying identification points and a second layer identifying words.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a block diagram of an alternative embodiment of the invention in a brick and mortar context, analogous to the expected preferred embodiments.

FIG. 2 is a block diagram of another alternative with embodiment back-end banking transactions of the system of the invention, in various embodiments.

FIG. 3 is a short flowchart of the overall method of the invention in either a brick and mortar POS context or an online “shopping cart” POS context.

FIG. 4 is a block diagram of a system and apparatus of the invention and the environment in which it might operate.

FIG. 5 is a flow chart of the registration operations of the system/apparatus and also of the method embodiment of the invention.

FIG. 6 is a flow chart of the purchase operations of the system/apparatus and also of the method embodiment of the invention.

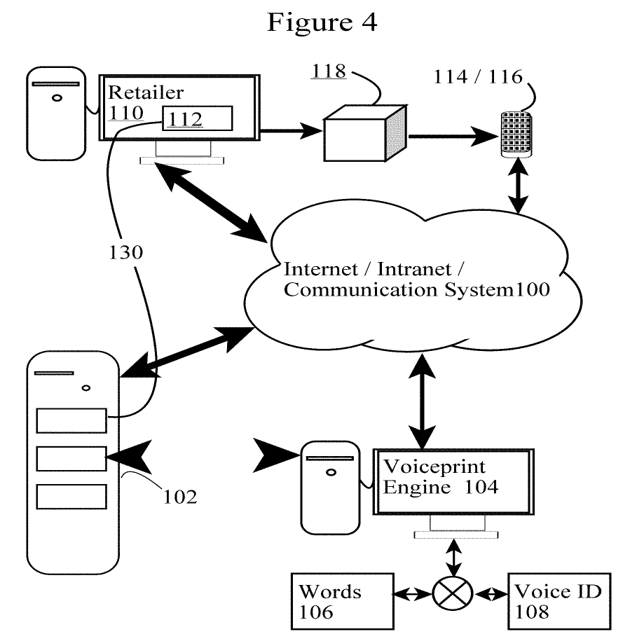

FIG. 4 is a table of flags set by the invention to indicate to a retailer the testing outcome status of a customer attempt to use the system.

FIG. 8 is an exemplary spectrogram of a sound such as might be tested by the system.

FIG. 9 is an exemplary oscilloscope diagram to show the difference between a spectrogram, which might be part of a preferred embodiment of the invention, and a more-commonly-seen but unlikely-to-be-used oscilloscope-type display of audio information.

FIG. 10 is a simplified block diagram of an individual customer record according to the invention.

FIG. 11 is a simplified exemplary spectrogram showing the use of the identification points as they are provided as input to an expert system.

FIG. 12 is an exemplary spectrogram and neural network identification system.

### INDEX TO THE REFERENCE NUMERALS

POS Terminal 2
Shop 4
Mobile device 6
Online shopping cart alternative 8
Third party voice purchase provider 10
Customer bank 12
Retailer bank 14
Online retailer bank 16
Customer 30
Mobile device 32
Voice purchase provider 34
Customer bank 36
Intermediary bank 38
Merchant bank 40
Shopping cart 42
Purchase 44
Shop 70
Speak purchase command 72
Verify user registration 74
Registration 76
Carry out financials of purchase and inform POS terminal/shopping cart 78
Network 100
Portal 102
Voice recognition engine (optional) 104
Word recognition & database module 106
Voice recognition & database module 108
Electronic Service/Retailer 110
Checkout page (XML, etc) 112
Consumer/Buyer 114
Browser (supports XML, etc) 116
Physical transfer of item/perform service 118
Registration offer from retailer/portal 200
Consumer decision 202
Request voice purchase command (words, voice) 204
Activate microphone 206
Return voice purchase command to retailer 208
Return voice purchase command to portal 210
Direct voice purchase command to VR engine 212
Database words and voiceprint associated with consumer identity 214
Pre-purchase activity (shopping) 300
Transmission of purchase page (HTML, XML, JAVA, FLASH, etc) 302
Consumer choice 304
Turn on microphone 306
Record verbal identity code candidate 308
Transmit candidate code to retailer 310
Forward candidate code to portal 312
Submit candidate code to engine for testing 314
Compare words to words associated with customer identity 316
Compare biometric voiceprint to voiceprint associated with customer identity 318
Compare audio recording to audio recording associated with customer identity 320
Determine test outcome, flag status 1-5 322
Return status to portal 324
Return status to retailer 326
Status is acceptable to retailer? 328
Complete transaction 330
Offer retry 332
Words and voice match, status 1 400
No match, status 2 402
EXACT (recorded) match, status 3 404
Only voice match, status 4 406
Only words match, status 5 408
. . . Other statuses, status 6+ 410
spectrogram 500
identification point 502
vertical time axis 504
horizontal frequency axis 506
oscilloscope display 600
record 700
customer name 702
recording of registration 704
biometric voiceprint id information 706
word choice information 708
status flags 710-720
word choice 722
bandwidth 724
mean frequency 726
body cavity resonance 728
pitch 730
shape of vowels 732
distribution of sound energy 734
pauses 736
stops 738
fricatives 740
plosives 742
credit card number 744
credit card security codes 746
credit card billing address 748
credit card name 750
bank account number 752
bank routing number 754
other financial data 756
shipping address 758
performance address 760
demographic data 762
electronic commerce history 764
spectrogram 800
feature/identification point 802
feature/identification point 804
expert system 806
spectrogram 900
feature/identification point 902
feature/identification point 904
feature layer 906
phoneme layer 908
word layer 910
neural node 912

### DETAILED DESCRIPTION OF EMBODIMENTS

Briefly and in general terms the present invention provides a better device and method for checking out. Rather than directly using the banking system from the POS terminal/shopping cart of the retailer to the bank, the present system teaches that the consumer may simply use a verbal command to “checkout” (or “add to cart”) which is then processed by cloud computing methods to initiate a transaction, carry out the banking/financial details from the cloud based third party service to the banks and back again (which optionally may include voice print ID or other voiceprint engines, but not necessarily) and then inform the POS terminal/shopping cart of the retailer of the successful conclusion of the transaction.

Note that in practice this will probably be both easier to implement and most practical, especially in the long term, in the electronic commerce environment rather than in brick and mortar retailers.

Therefore, the present invention may in embodiments further provide a system that facilitates purchase transactions within social network environments by enabling online consumers to checkout quicker and more easily through a simply posting to their profile page, newsfeed, or status update. The system includes a search engine and a payment processing component. The search engine monitors the posts on one or more social networks in search of particular strings of characters that indicates a social network user's intent to purchase a product. The search engine may be limited to monitoring a particular group of users or all users on a social network. For example, the search engine may limit itself to monitoring the accounts of social network users that receive an offer message from an online merchant user account or to the followers, connections, or friends of a merchant that posts an offer.

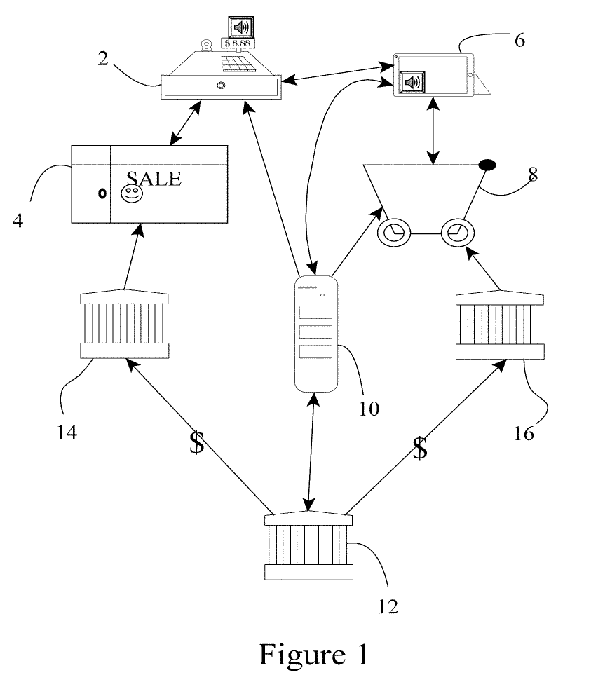

FIG. 1 is a block diagram of an alternative embodiment of the invention in a brick and mortar context, analogous to the expected preferred embodiments. POS Terminal 2 may be located in shop 4. User's mobile device 6, or the POST 4, may have a microphone to allow the user to trigger a purchase by voice command.

Note that with the meteoric rise of online shopping, in the future the online shopping cart alternative 8 is expected to be the major application of the invention.

Voice command for a purchase accesses the third party voice purchase provider 10 (for example MOJOPAY®) which verifies the registration of the user (that they have signed up for voice purchase, provided sufficient financial information to do a transaction, and if necessary identification), then using the pre-existing financial information the third party uses its own payment system to access the customer's bank 12 (or banking equivalent, a different function than server 10 but also possible MOJOPAY® or legacy systems such as PAYPAL®), which pays the retailer's bank 14.

Notice that there are two routes shown by which the third party server 10 may be accessed. While it is possible, in more traditional settings, to access the server 10 via something like a microphone on a POS 2, it is anticipated that the major usage will be by means of mobile devices 6. In particular, while the mobile device 6 may be a shop POS itself (increasingly small businesses use mobile devices as POS terminals), but this is not the expected route of maximum efficiency. In practice, it is assumed that the user's own mobile device, voice activated, will be the first element of the entire POS system of this invention.

Also, the present system works with online retailers: the user may use their mobile device 6 (or a PC, not shown, or other device) to shop online, then access the third party server 10 which sends payment from the customer's bank 12 (using the stored financial information provided when the user first registered) to pay the online retailer bank 16.

Note that money and credit card information, bank routing information and the like all fall within the category of “financial Instruments” as used herein, meaning negotiable paper, money, credit transactions, debit transactions and the like.

IN ANY CASE, it is worth noting that in fact the POS process is now broken into multiple hardware pieces. In particular, the traditional online shopping cart or brick and mortar POS terminal is now more or less INFORMED AFTER THE TRANSACTION IS ALREADY COMPLETED. (In most likely scenarios, the shop/shopping car will know of the transaction going in, but still, the transaction is functionally effectuated without the traditional hardware). So for example, at server 10 it may be seen that the arrow points from the third party server 10 to the POS/shopping cart: the third party informs the shopping cart the transaction has occurred, rather than the other way round.

In addition, the user does not need to enter their financial data for each and every transaction: they need not swipe/insert/type in credit card numbers or enter payment system passcodes or the like.

In practice again, there will often be usual security measures in place, equivalent to checking a photo ID in-store, for example, biometric voiceprint or the like. Such services and engines are readily available (for example, see the references cited in the Background of this application, such as Ganti, Skerpac or the like) or can be developed. This optional additional security layer is likely to be commercially desirable.

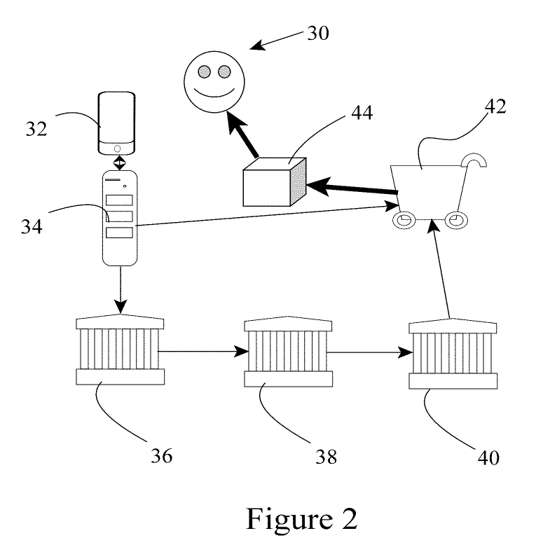

FIG. 2 is a block diagram of another alternative with embodiment back-end banking transactions of the system of the invention, in various embodiments. Customer 30 uses mobile device 32 having a microphone (such as shown in FIG. 1) to issue a verbal command such as “buy now”, or “add to my cart”, and thus accesses the voice purchase provider 34 (operating server 10 of the previous drawing). The voice purchase provider 34 verifies the transaction and then actually does the transaction in the background, without requiring any further financial information from the customer 30 (who provided that information a single time when registering for the service 34). Customer bank 36 and intermediary bank 38 arranged payment to merchant bank 40 (once again, note the potential to use more modern payment systems rather than traditional banks). Shopping cart 42 is informed of the transaction and the purchase item 44 is shipped as shown by thicker arrows.

As discussed previously, the user may well be shopping from a social media platform, see a post or advertisement for a product and speak the command “add that to my cart”: in such cases the social media platform may have this capability built-in, or the capability may be present in an extension or the like, or the mobile device may have a monitor function to catch the command without the social media platform being invoked at all.

In addition, the present invention may itself go out and invoke a shopping cart. In this scenario the user will see a product in a non-shopping context, command a purchase, and the third party system and device of the invention will create a shopping cart and consummate the purchase without further indications from the user.

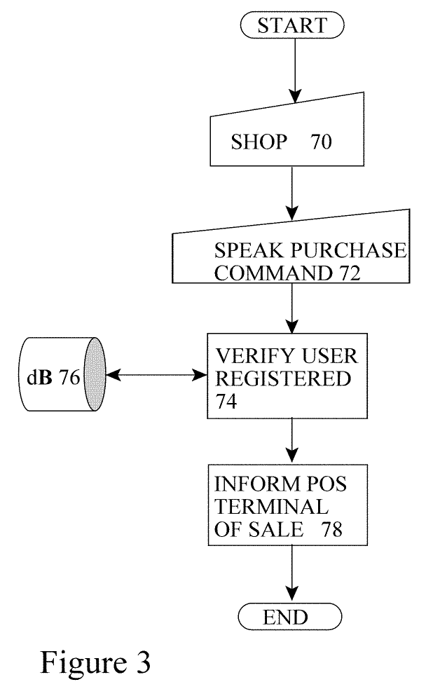

FIG. 3 is a short flowchart of the overall method of the invention in either a brick and mortar POS context or an online “shopping cart” POS context.

The simplicity of the system as shown is not the preferred embodiment but is rather instructive only: the overall flow chart aids in seeing what the invention is and is not. Shopping step 70 is manually carried out by the customer, who then manually speaks the purchase command 72 to cause the third party service to verify user registration 74, check the registration/security in database 76, do the transaction and inform the shopping cart of the sale 78.

FIG. 4 is a block diagram of an online system and apparatus of the invention and the environment in which it might operate.

Network 100 may in preferred embodiments and the best mode now contemplated be the Internet, however, it may also be an intranet, a private network, either a physical network or a network which is actually comprised of communication protocols or codes not open to the general public (all such systems are included in the term “closed garden” as used herein), a telephone network and so on.

Portal 102 is the intermediary service which provides the voice purchase payment option to both retailers and customers. Portal 102 serves the function of a commercial enterprise, offering electronic retailers of goods and services the intermediary service of payment verification by means of voice purchase technology. Note that in alternative embodiments the portal may be eliminated and the electronic retailers may use the service for their own customer base and with their own voice recognition/voiceprint engine and database.

Thus in the online version, the retailer will contact the third party service, which will then carry out the banking functions of the purchase transaction and return to the retailer the information that the transaction has occurred (or not occurred). Thus the transaction may be triggered (initiated, carried out, etc) by means of the voice command of the user.

Voice recognition engine 104 may contain its own voiceprint and voice recognition algorithms and modules, and in addition may contain word recognition & database module 106 and voice recognition & database module 108. Note that theoretically the biometric part of the invention is not necessary.

For the present application, the term voiceprint and the term voice recognition are not synonymous.

Voice recognition (VR) in the present application means the ability to hear a human voice speak and from that voice determine the word or words that were spoken. This initiates a purchase, and if successful, completes the purchase as well. (Also, this capability allows an extra layer of security to be added to the invention, in a pseudo-multi-modal framework, as discussed below in other alternative embodiments.)

Voiceprint technology on the other hand refers to the ability to identify, exactly, a particular voice as being that of a particular person. This is the basic identification ability used in the present invention, albeit supplemented as discussed elsewhere.

Electronic service/retailer 110 may purvey physical goods (books, clothing, electronics and so on), electronic goods (video, music, etc), services either physical or online (a maid service, accounting, etc). Sales/purchases made may be actual sales of title in goods, or may be contracts for services, licenses to playing of entertainment and so on. The crucial fact is that the retailer 110 has an online shopping presence which includes a checkout page (in HTML, XML, etc) 112. At this checkout page the customer is presented with an electronic point-of-sale and money actually changes hands, being transferred from one credit account or bank account to another. This transfer of money, which may be represented by cash, can in fact include within the scope of the invention the physical transfer of cash money by electronic means and withdrawal.

Note that in one preferred embodiment the “checkout page” 112 may actually be a social media post, image, page or the like, which displays a product that some other social media user has posted. Thus the “retailer” is in fact merely a witting or unwitting social media environment, with the actual seller hidden elsewhere and possibly even unaware of the posting. In use, the social media environment sends the voice command “buy it” to the third party intermediary, who processes the transaction financially and notifies the actual seller to complete the physical transaction. This could occur brick and mortar or online, despite the social media aspect: the buyer might see the posting in social media while in a physical store.

One additional step within the scope of the invention may be the transfer of money, followed by that withdrawal, thus effecting the physical moving of money.

Consumer/Buyer 114 might more accurately be represented by their electronic browsing device: a smart telephone, a tablet, a computer, or even a dumb telephone terminal.

Browser 116 supports common page transfer protocols such as HTML, XML, XHTML, JAVA and the like, by which means webpages may be easily displayed on the electronic browsing device 114.

Physical transfer of item/perform service/transfer of money 118 is seen to occur outside of the electronic context, that is, the present invention results in the transfer of tangible physical items such as diamonds, tires, etc. The present invention may, as discussed previously, entirely occur in the brick and mortar context.

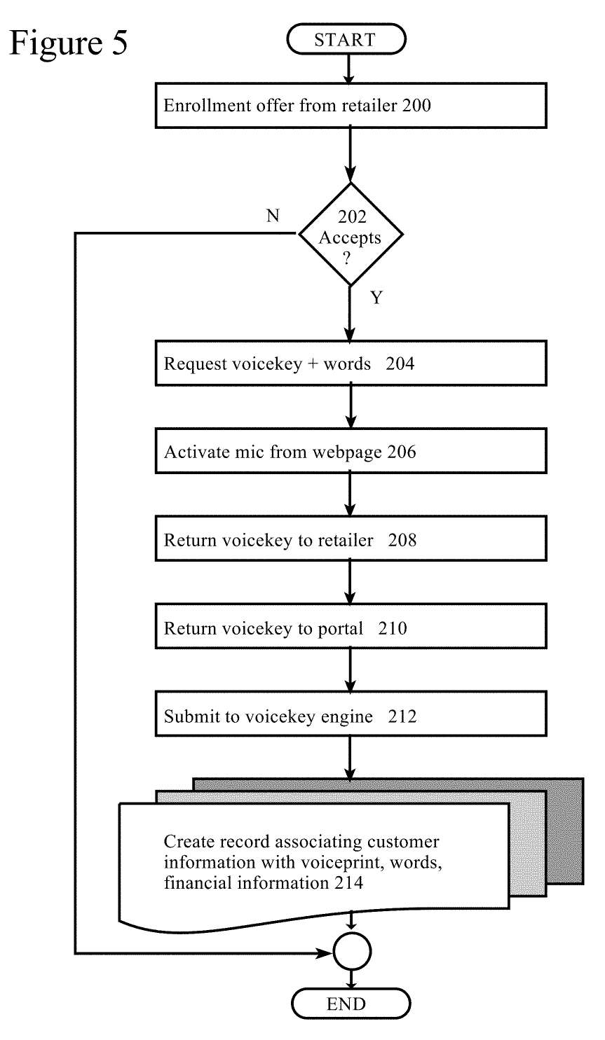

FIG. 5 is a flow chart of the registration operations of the system/apparatus and also of the method embodiment of the invention. This is an optional step in the invention, as the database may be assembled by means other than individualized registration, however, the preferred embodiment and best mode now contemplated is a registration offer from retailer or portal, as seen at step 200. Consumer decision to register 202 initiates the process.

The first step thereafter is a request for a voice purchase command (possibly including as security measures both choice of words, and voice), step 204. For typical purposes, such a voice purchase command may be quite short, however, a tradeoff between security and convenience ensues, as the word “the” or “and” alone would be unlikely to provide much security, while a recitation of a long poem would likely lead to memory errors, not to mention wasted digital capacity in terms of electronic bandwidth or storage or processing. Thus, a typical range of words for the pass phrase might be from 10 to 20 words, with more or fewer easily possible. The registering new user will have these issues explained in brief before being urged to think of a purchase phrase which will always come easily to memory and lips.

Activation of the customer's microphone at step 206 is followed by the recording of the pass phrase for the first time. This is then returned as a voice purchase command to the retailer 208 or directly returned as a voice purchase command to the portal 210, or via the retailer to the portal.

The portal may then enter the voice purchase command, unprocessed or processed, into a portal database, for example as an optional security and pass phrase recovery feature. However, the main use of the new voice purchase/voice purchase command is for further processing for identification purposes.

The new voice purchase command is thus directed/submitted to the optional voiceprint/VR engine 212 which then processes it, choosing the marker points which help identify the customer, reducing the audio recording (likely to be a file in a format such as MP3, WAV, or other more modem formats now known or later devised) to a usable voiceprint data set, which is then stored in the database. These words and voiceprint are then associated with the consumer identity in the database, in step 214.

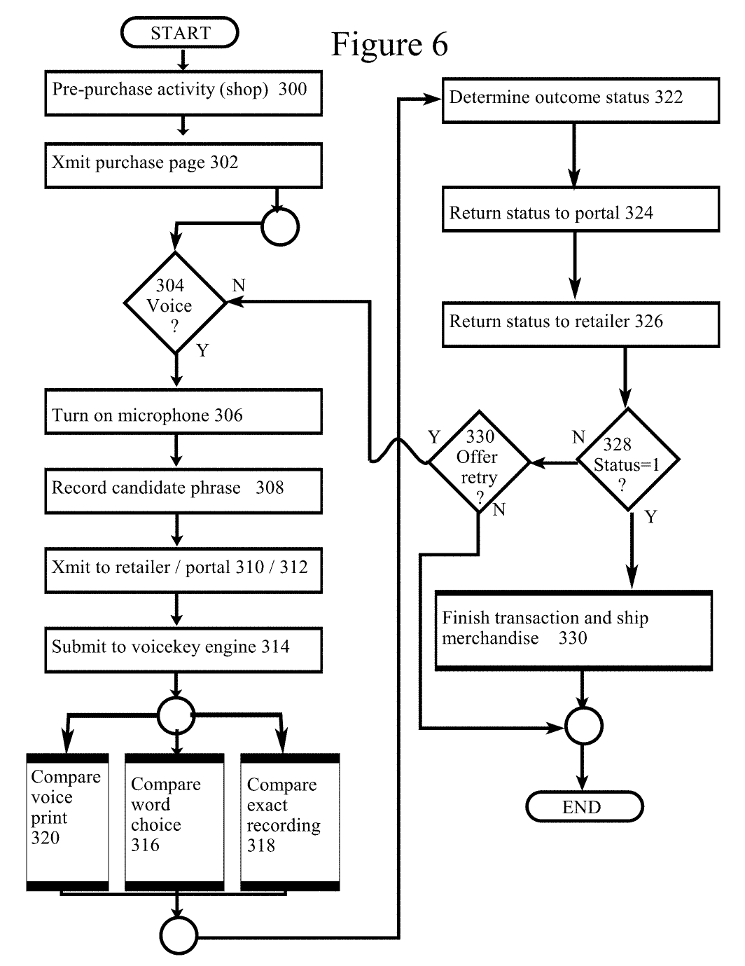

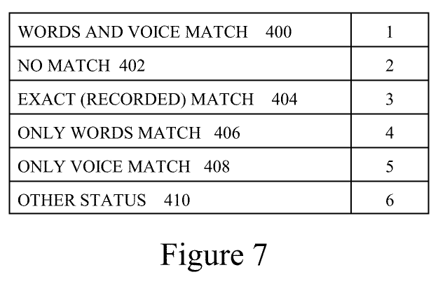

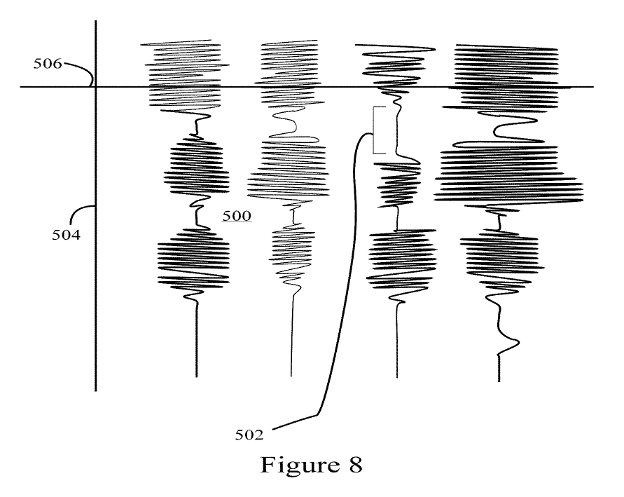

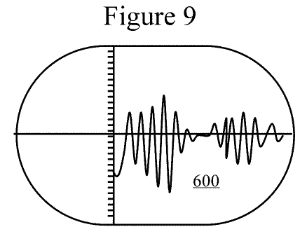

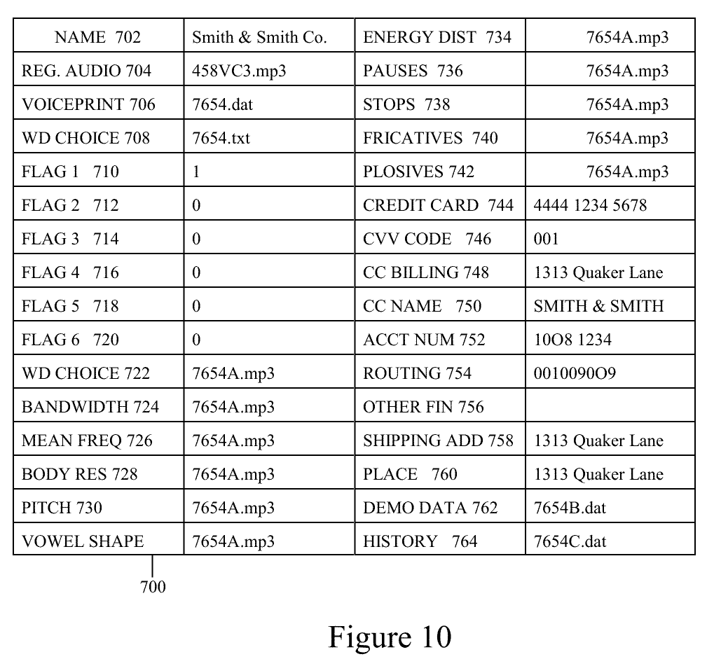

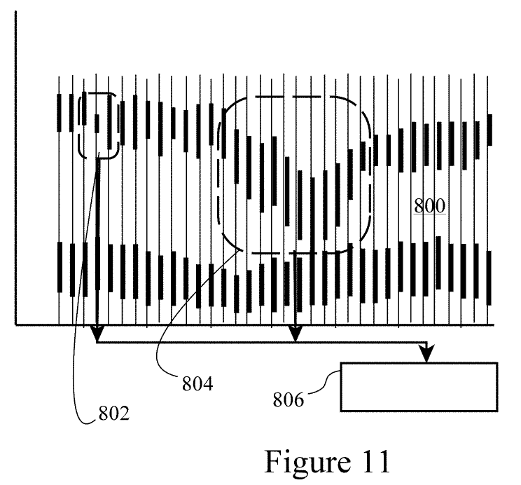

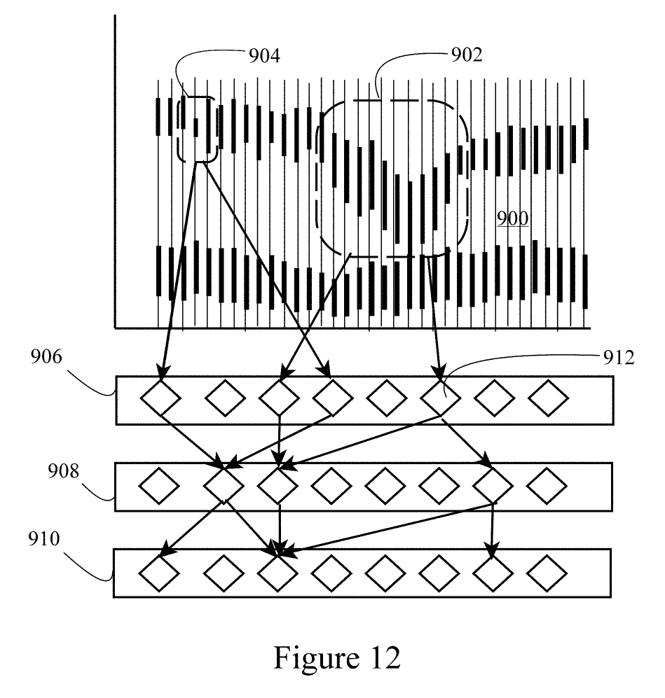

Turning now to a typical purchase, FIG. 6 is a flow chart of the purchase operations of the system/apparatus and also of the method embodiment of the invention.

Pre-purchase activity 300 is more or less shopping. When a purchase is requested by the consumer, the current invention is then invoked by the transmission of a purchase page, again in HTML, XML, JAVA, etc, at step 302. The purchase page may have embedded normally within it the code necessary to carry out a transaction, that is, it can activate a microphone, make a recording, etc. It may in less preferred embodiments have this embedded by addition of a downloaded app, applet, add-on, plug-in or the like.

Customer choice 304 is that step at which the customer makes an election to use the process of voice checkout. This invokes the routine to follow, in which the device turns on the microphone (step 306) and records the verbal purchase code candidate at step 308. This then is transmitted as shown, to the retailer (310) and thence to the portal at step 312 or else directly to the portal.

This then submits 314 the candidate code to engine for testing. Engines such as those found in use may be used, or specialty engines may be adopted. In embodiments no engine may be used, albeit with the potential for possible security issues.

Testing will normally have a minimum of one component (the comparison of biometric voiceprint to the voiceprint associated with the customer identity 318) but may have up to three, including as well the comparisons of words to words associated with the customer identity at step 316, and a comparison of audio recording (the candidate) to audio recording (the original registration) associated with customer identity at step 320. These optional steps are depicted concurrently but may be carried out in parallel.

This allows determination of a test outcome, which can be represented by a status flag one through five being set at step 322. The status of the testing is then returned to the portal at step 324 as shown, or else goes directly to the retailer. If it is sent through the portal the portal will then forward it to the retailer as shown at step 326.

The retailer, or more accurately the retailer's third party server system, will then encounter a decision: is the status is acceptable to the retailer? (Step 328). In general, only the flag indicating a successful voiceprint match will be acceptable but the retailer can make various determinations, for example, that a failure based on incorrect word choice will lead to an offer to retry the transaction (step 332) while a failure based upon use of a tape recording or the correct words but wrong voice will initiate an anti-fraud activity and so on. The retailer may have provided its choices in these matters to the third party server system in advance, rather than on an ad hoc basis.

If the status indicates a successful verification, then the next step is completion of the transaction 330, including financial processing by the third party system interacting with the banking system, the shipment of a product from the retailer to the customer, or the carrying out of a service activity.

FIG. 4 is a table of flags set by the invention to indicate to the third party server (or to the retailer in embodiments without a third party) what is the testing outcome status of a customer attempt to use the system. Words and voice match, status 1, (400) indicates that both words and voice matched, a successful verification of the candidate input. No match, status 2, (402) indicates a failure of the testing. Exact (recorded) match, status 3 (404) could be an indication of fraud, as could status 5, in which only the words match (410). On the other hand if only the voice matches, status 4 (406) a retailer might choose to interpret this as indicating that the customer has forgotten their voice-key. Other statuses, status 6+(410) are also possible in alternative embodiments.

FIG. 8 is an exemplary spectrogram a sound such as might be tested by the system with a manual or automated verification embodiment. Manual verification is a much less preferred for reasons of time and economics.

Spectrogram 500 has a typical identification point such as those listed previously. Identification point 502 may be part of a larger sound analysis made with a vertical time axis 504 and a horizontal frequency axis 506. The voiceprint engine might analyze such identification points in order to help ascertain the identity of a voice candidate.

FIG. 9 is an exemplary oscilloscope diagram to show the difference between a spectrogram, which might be part of a preferred embodiment of the invention, and an oscilloscope-type display of audio information. Oscilloscope display 600 can be used for voice identification (amplitude vertical axis versus frequency horizontal axis) but it is less desirable.

Digital methods using advanced algorithms without any graphical display are the preferred embodiment, as such digital methods allow very fast voiceprint identification with minimal or no human oversight.

FIG. 10 is a simplified block diagram of an individual customer record according to the invention.

Record 700 has numerous individual fields of data therein. Customer name 702 may be a business name or an individual name, and may be broken up (first name, last name, etc). A check against fraud by use of digital or analog audio recordings of an individual's pass phrase may be conducted if a recording of the original voice registration 704 is maintained, note that this recording can be a complete recording, or it can be an encryption of a recording of the original registration, or a compacted or edited form thereof, such as a short snippet, a mathematical extraction therefrom, etc.

Biometric voiceprint id information 706 and word choice information 708 are fairly obvious optional components of the overall system. It is worth noting that in most economical systems the words used by the customer MUST be the same each time, that is, the word choice and voiceprint information are in fact inseparable. However, by means of voice recognition technology to sort out the exact words used, and by means of voiceprint technology which can identify a voice even when uttering words not heard by the system previously, it is possible to separate these. Since such separation is a desirable security feature, the use of more complicated systems which employ that is preferable.

Status flags 710-720 represent, among other things, the outcome of such a divided analysis. As noted previously in regard to FIG. 8, flag field 710 (status flag 1) may represent a match, flag field 712 (status flag 2) may represent no match, while 714 (status flag 3) may represent an exact match, suspected of being a recording. Flags 716 (flag 4) and 718 (status 5) may represent words matching or the voice matching—status flag 4 (716) in particular raising a suspicion of fraud—while flag 720 may represent yet another possible outcome of testing.

Word choice 722 may represent a data field containing text or code which indicates the exact wording of the pass phrase in human accessible format. This could be useful for password recovery functions and the like.

Bandwidth 724, mean frequency 726, body cavity resonance 728 (nasal passage resonance, lung resonance, etc), pitch 730, vowel shape 732, the overall distribution of vocal energy 734, the length, position and sound of pauses 736, stops 738, fricatives 740 and even plosives 742 are all other quantities customarily used in traditional voiceprint analysis, however, for purposes of the present application more accurate and more modern acoustic qualities may be used instead within the scope of the present invention.

Typical consumer financial data may include payment information, with the obvious fields for credit card number 744, credit card security codes 746, credit card billing address 748, and credit card name 750, as well as or in the alternative including bank account number 752, ABA bank routing number 754 and the like. Further financial data 756 may be stored as well.

While not normally considered “financial” data, for the purposes of electronic business other quantities of the customer are also financial data: the nature of their domicile (single family, multi-unit, commercial, retail, etc), whether they rent or own, location of physical shipping/performance and so on may be subsumed fairly easily with shipping address 758/performance address 760. In addition, this data can be combined to become of value to the company in the area of data mining, for example when combined with demographic data 762 and electronic commerce history 764.

FIG. 11 is a simplified exemplary spectrogram showing the use of the identification points as they are provided as input to an expert system. Spectrogram 800 has several identification points, such as rises or dips in the overall shape during time (for example feature/identification point 802) or a sharp drop in a particular frequency (for example feature/identification point 804). This information may be detected and provided to expert system 806, which is a voice recognition system.

Such VR systems are usually used for IVR systems, for example for consumer bill payments, however, the systems may also be used for security, as in the present invention. In addition, the expert system may be used for voice identification as well as voice recognition, thus providing an extra layer of security.

FIG. 12 is an exemplary spectrogram and neural network identification system. In this case the expert system of FIG. 11 is replaced by a more detailed diagram of a more sophisticated type of system.

Neural networks are considered to be one possible method of dealing with extremely fuzzy data sets which are normally too difficult for a standard computer to analyze. In particular, it has been found that voice recognition and voice identification are areas in which neural networks may be profitably employed. Such networks normally operate by having multiple layers of nodes which each have only a few inputs and outputs and very simple processing capabilities. When a signal reaches a given node, that node may analyze only a single aspect or characteristic of the signal.

Such networks achieve their highly effective results by providing a multiplicity of such nodes which all operate together in an arrangement both sequential and parallel. Thus, the signal goes to a first layer of the network, where several nodes recognize different aspects of it and based on their individually very simple analysis, in turn activate the appropriate nodes in the second layer. Since several nodes in the first layer are doing this at the same time, several nodes in the second layer are not activated and the process is repeated for the second layer nodes which were activated, which then send the signal to appropriate nodes of a third layer, based upon their own simply individualized analysis.

There may be more than three layers and in addition, while in this example the signal is seen passing through the system in only one direction, a node in the second layer can also activate a node in the first layer, in effect sending the signal backward briefly. Layers may be skipped and the signal strength of any given activation may be employed as another form of neural mimicry. The system may also feature recursion and feedback as well as adjustable node responses and may thus “teach” itself based on previous outcomes.

In the end, the final answer provided may be much more accurate than a single, algorithmic, analysis could have provided.

In FIG. 12, spectrogram 900 is seen to have various features, indicating fluctuations in the sound waves such as the general reduction of energy of feature/identification point 902 or the localized reduction of energy of feature/identification point 904. The embodiment of FIG. 12 is similar to the TRACE system of language recognition, in that there are three layers (feature, phenome, and word) and the system uses the spectrogram for input. Feature layer 906 accepts these features: some nodes are not activated, others are activated depending on the nature of the feature being analyzed. In turn these nodes have been trained or programmed, depending on the nature of the system, to activate certain other nodes in the phoneme layer 908. (A phoneme is a very small part of audible speech, for example, a phoneme might correspond to a single vowel sound.) The phoneme layer 908 might then analyze the results in terms of phonemes and send the results to a word layer 910. One neural node 912 is shown activated and receiving and input and determining which other nodes should then be activated based thereon.

It will be seen that one advantage of such a system is that if it has been programmed or trained to accept a particular user's voice, then it can not only sort out words but can also identify the fact that a later provided sound sample is not the correct user, and can do so as part of its normal operation in any case.

### Example One

A customer in a shop approaches the POS terminal and retrieves their mobile device. They input (for example bar code scanning by the POS terminal or QR scanning by the mobile device) the items to be purchased, then say to their mobile device. “buy it”. The mobile device has not token thereon, instead it sends the purchase command to the third party server, which verifies that the customer is enrolled. The third party then uses the stored financial information to activate the banking payment system (for example the customer's credit card information) and the banking system carries out the transaction, eventually crediting the shop's merchant account. The third party system then notifies the POS terminal directly that the transaction has been triggered, processed, and payment has been received, and POS terminal does nothing else, or may print out a receipt.

This system has no internal security, as the shop clerk then checks the customer's ID. No voiceprint engine is required.

### Example Two

In this example steps and modules belonging to different diagrams are referred to in order of usage, rather than in numerical order.

In this example a business person customer needs a temporary employee for inventory work and using their computer, locates an online temping agency and goes through the agency's website and determines that they wish to have the inventory worker assigned as soon as possible.

However at step 302, when the “Voice checkout” option is offered, the business person customer recognizes that they have never registered their business for voice checkout, and further realizes that voice checkout would be convenient. They select the option and are directed to the registration system. The system asks them for normal commercial information (company name, the location at which services are to be performed, credit card or banking information and so on) and then activates the microphone 206, returns 208 the recorded choice of words, in the voice of the customer, forwards the words to the portal (step 210, module 102), and then their information is properly associated in a new record 700. The complete recording may optionally be saved for testing in order to prevent the use of audio files to dupe the system, the customer's business name and other information may be stored in the database and so on. In addition voiceprint engine 104 receives the words and voice, returns the text version of the words (after VR) to record 700, field 722, stores the marker points which will be used to test future purchases, and processing stops.

At this point, the new customer is returned to the start of the purchase operation and procedures follow the general outline of the procedures of Example One above, with the caveat that the physical result is inventory servicing by a temporary employee who comes to the business person's address.

### Example Three

In this example steps and modules belonging to different diagrams are referred to in order of usage, rather than in numerical order.

An example of the use of the present invention might be a customer who ventures online 100 (using a tablet device 114 to browse the Internet) as the customer shops for an item of clothing. Thus, this would be an example of a sale of good to a consumer for personal use. The consumer locates the item that they wish to purchase at the electronic store of a retailer. The consumer adds the item to an electronic shopping cart and then moves on to a check-out page.

The retailer's check-out page 112 is of course actually downloaded 302 quickly and temporality to the temporary folders of the consumer computer, and it has embedded therein a piece of XML code which displays to the consumer several check-out options as soft buttons. Noting that the “Voice Checkout” button exists, the consumer selects the “Voice Checkout” button and the embedded code which is part of the check-out page 112 begins to operate. It indicates to the consumer that they should speak their verbal purchase phrase 706, including the correct words 708, and it activates 300 the microphone of the table device 114 to record 308 the sound.

The recording, now a candidate for testing, may for additional security be hashed, encrypted, etc, and is then transmitted to the retailer 310, transmitted again 312 to the portal, and submitted 314 by the portal to the voiceprint identification engine 104. The engine 104 then runs three comparisons, comparison (via voice recognition) of word choice 316, of voiceprint 320, and in addition, it performs a check 318 to make sure that an audio recording (digital, analog, or by any mechanism) is not being employed.

The consumer has forgotten the correct wording in this case.

The engine 104 will then set a test outcome status flag 322 (and 710-720), or more than one flag, based on the test of the candidate sound. Assuming for the sake of the example that the test is failed, and that the voice matches but the words are incorrect, flag 5 is set. This status is returned to the portal 324 and thence to the retailer 326.

Retailer 326 may optionally have different responses coded. In steps 326 and 332, the retailer does not approve of the transaction but does offer the customer a retry, returning processing back to step 304. This time, the consumer remembers the correct words and the status flag returned is 1, indicating a match. At step 320 the processing continues to step 330 and the merchandise is shipped to the consumer.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims. Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A device for checking out, for use by a single customer, the device comprising:
a database having a plurality of records, each record associated with such single customer,
each record having commercial information associated with such customer;
each record having a purchase command associated with such customer;
a microphone operative to accept the purchase command and transmit it to the database;
a financial transaction system operative to use the commercial information to conduct a complete purchase without further input from such customer, including the steps of:
verifying the purchase command;
transferring a financial instrument from such customer using the commercial information associated with such customer;
transferring the financial instrument to a first retailer;
informing a POS terminal/shopping cart belonging to the first retailer of the successful purchase; and
ordering shipment of a product to such customer.

2. The device of claim 1, wherein the device for checking out further comprises one member selected from the group consisting of: a POS terminal, a mobile device owned by a brick and mortar retailer, a cloud based third party service, and combinations thereof.

3. The device of claim 2, wherein the database is written upon a non-volatile memory medium within at least one computer system.

4. The device of claim 3, wherein the commercial information further comprises: one member selected from the group consisting of: credit card number, credit card security codes, credit card billing address, credit card name, bank account number and routing number, other financial data, shipping address, demographic data, electronic commerce history and combinations thereof.

5. The device for checking out of claim 4, further comprising:
a biometric voiceprint engine;
the biometric voiceprint engine operative to receive the purchase command and test it against a biometric voiceprint identity information previously registered by such customer and a word choice identity information previously registered by such;
a status determination from such biometric voiceprint engine indicating the outcome of the test and assign a test outcome status to the purchase command;
the biometric voiceprint engine operative to return the status determination to the financial transaction system.

6. A method of voice purchase offered by an electronic retailer, for use by a customer having an electronic browsing device, the method comprising the steps of:
providing a database having a plurality of records, each record associated with a single customer,
each record having commercial information associated with such customer;
each record having biometric voiceprint identity information associated with such customer;
each record having word choice identity information associated with such customer;
providing a product/service for purchase by such customer;
transmitting to such customer a purchase page;
offering such customer the option of voice checkout and proceeding with the following steps if the customer elects voice checkout
activating a microphone on such customer's electronic browsing device;
recording the customer's verbal identity code candidate;
transmitting the verbal identity code candidate to a voice checkout portal;
submitting the verbal identity code candidate to a biometric voiceprint engine for testing;
comparing words in the verbal identity code candidate to word choice identity information associated with such customer;
comparing biometric voiceprint information in the verbal identity code candidate to the biometric voiceprint identity information associated with such customer;
based upon the results of the comparisons of the verbal identity code candidate to the information associated with such customer, assigning a test outcome status to the verbal identity code candidate;
returning the test outcome status to such electronic retailer;
determining if the test outcome status is acceptable to such electronic retailer;
if the test outcome status is acceptable to such electronic retailer, completing a purchase, including providing the service/shipping the product;
if the test outcome status is not acceptable to such electronic retailer, determining if the test outcome status merits raising a fraud detection flag;
if the test outcome status does not merit raising a fraud detection flag, determining if such electronic retailer wishes to offer such customer a chance to retry the voice checkout and if so, returning to the step of offering such customer the option of voice checkout.

7. The method of online commerce of claim 6, wherein the step of providing a database having a plurality of records, further comprises:
providing an online commerce site;
providing a registration process in turn comprising the steps of:
offering to such customer the opportunity to register for voice checkout;
if such customer accepts the opportunity to register for voice checkout, creating the record associated with such customer;
obtaining from such customer the customer's commercial information and associating that commercial information with such customer in the record;
activating the microphone on such customer's electronic browsing device;
recording a pass phrase including both biometric voiceprint identity information and word choice identity information;
transmitting to the voice checkout portal the pass phrase;
submitting the pass phrase to the biometric voiceprint engine;
associating that information with such customer in the record, including associating the biometric voiceprint identity information and the word choice identity information with the customer.

8. The method of online commerce of claim 6, wherein the purchase page is encoded using one member selected from the group consisting of: XML, HTML, XHTML, JAVA, PHP, ASP .net, HTML5, FLASH, Silverlight, Quicktime, iOS, Android, a programming language now known or later developed and combinations thereof.

9. The method of online commerce of claim 6, wherein the transmissions of the method are carried out using one member selected from the group consisting of: the Internet, an intranet, ‘closed garden’ protocols, voice transmissions and combinations thereof.

10. An voice purchase portal for use by a customer having an electronic browsing device and an electronic retailer offering an electronic purchase page, the portal comprising:
a database having a plurality of records, each record associated with a single customer,
each record having commercial information associated with such customer;
each record having biometric voiceprint identity information associated with such customer;
each record having word choice identity information associated with such customer;
a purchase page module provided by the voice purchase portal to such electronic retailer for insertion into a purchase page, the purchase page module operative to activate a microphone on such customer's electronic browsing device and record voice information; the purchase page module further operative to transmit such verbal identity code candidate to the voice purchase portal;
the voice purchase portal operative to submit the verbal identity code information to a biometric voiceprint engine;
the biometric voiceprint engine operative to receive a verbal identity code candidate and test it against such biometric voiceprint identity information and such word choice identity information;
a status determination module operative to receive from such biometric voiceprint engine the outcome of such test and assign a test outcome status to the verbal identity code candidate;
the modules of the portal written upon a non-volatile memory medium within at least one computer system.

11. The voice purchase portal of claim 10, further comprising:
a registration module operative to offer to such customer the opportunity to register for voice checkout; the registration module further operative to create the record associated with such customer, obtain from such customer the customer's commercial information and associating that commercial information with such customer in the record;
the registration module further operative to activate the microphone on such customer's electronic browsing device and record a pass phrase including both biometric voiceprint identity information and word choice identity information and then submit the pass phrase to the biometric voiceprint engine while associating that information with such customer in the record, including associating the biometric voiceprint identity information and the word choice identity information with the customer.

12. The voice purchase portal of claim 11, the registration module further operative to associate an exact recording information of the pass phrase with such customer in the record, the biometric voiceprint engine further operative to compare exact audio recording information of the verbal identity code candidate to the exact audio recording information associated with the customer.

13. The voice purchase portal of claim 12, wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

14. The voice purchase portal of claim 10, wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

15. The voice purchase portal of claim 10, wherein the biometric voiceprint information further comprises one member selected from the group consisting of: word choice, bandwidth, mean frequency, body cavity resonance, pitch, shape of vowels, distribution of sound energy, pauses, stops, fricatives, plosives and combinations thereof.

16. The voice purchase portal of claim 10, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

17. The voice purchase portal of claim 10, wherein the transmissions of the method are carried out using one member selected from the group consisting of: the Internet, an intranet, closed garden protocols, voice transmissions and combinations thereof.
